(19) United States
(12) Patent Application Publication
(10) Pub. No.: US 2018/0149085 A1
(43) Pub. Date: May 31, 2018

(54) EXHAUST FRAME COOLING VIA COOLING FLOW REVERSAL

(71) Applicant: General Electric Company, Schenectady, NY (US)

(72) Inventors: Veerraju Chennoju, Bangalore (IN); Debabrata Mukhopadhyay, Bangalore (IN); Rohit Pruthi, Bangalore (IN)

(21) Appl. No.: 15/362,202

(22) Filed: Nov. 28, 2016

(51) Int. Cl. F02C 7/18

(52) U.S. Cl. CPC F02C 7/18; F05D 2260/232

(57) ABSTRACT

This application provides exhaust frame cooling systems for use with gas turbine engines. Example systems may include an exhaust system for use with a gas turbine engine. The exhaust system may include a strut positioned between an inner barrel and an outer barrel. The strut may include an inner body and an outer body. The exhaust system may include at least one strut hole formed in the inner body, where the at least one strut hole forms a first cooling path for cooling flow in a first direction, a cavity between the inner body and the outer body, where the cavity forms a second cooling path for the cooling flow in a second direction, and a purge outlet to purge the cooling flow at the inner barrel.

### TECHNICAL FIELD

The present application and the resultant patent relate generally to gas turbine engines and more particularly relate to a cooling system for gas turbine engine exhaust frames.

### BACKGROUND OF THE INVENTION

In a gas turbine engine, hot combustion gases generated in one or more combustors generally may flow along a hot gas path extending through a turbine and an exhaust frame positioned downstream of the turbine. The exhaust frame may include an inner barrel, an outer barrel, and a number of struts extending between the inner barrel and the outer barrel. The inner barrel may house a shaft bearing that supports a main shaft of the gas turbine engine therein. The combustion gases flowing through the exhaust frame may be contained between the inner barrel and the outer barrel and may flow over the struts. In this manner, the inner barrel, the outer barrel, and the struts may be subjected to high temperatures resulting from the flow of combustion gases along the hot gas path, which may result in the generation of high thermal stresses in these components and the interfaces therebetween. Because the efficiency of a gas turbine engine is dependent on its operating temperatures, there is an ongoing demand for components positioned along and within the hot gas path, such as the inner barrel, the outer barrel, and the struts of the exhaust frame, to be capable of withstanding increasingly higher temperatures without deterioration, failure, or decrease in useful life.

According to certain exhaust frame configurations, struts may be welded or otherwise attached at one end to the inner barrel and at another end to the outer barrel. During operation of the gas turbine engine, high stresses may be generated in the struts, particularly in the welded or attachment portions adjacent the inner barrel and the outer barrel, due to large temperature gradients produced in the exhaust frame. For example, during startup of the gas turbine engine, high stresses may be generated as the struts heat up faster than the inner barrel and the outer barrel. In a similar manner, high stresses may be generated during shut down of the gas turbine engine, as the struts cool down faster than the inner barrel and the outer barrel. During steady state operation of the gas turbine engine, high stresses may be generated due to cooling of the inner barrel and/or the outer barrel, such as via a cooling air system or external air, while the struts experience higher temperatures within the hot gas path. Additionally, when the inner barrel is used to support the shaft bearing, high stresses may be generated in the struts due to imbalance of the main shaft, as may result from a “blade out” event or other causes. Stress concentrations in the struts may increase a risk of failure of the welds or may cause the struts to separate from the inner barrel of the turbine exhaust system.

### SUMMARY OF THE INVENTION

This application and the resultant patent provide an exhaust system for use with a gas turbine engine. The exhaust system may include a strut positioned between an inner barrel and an outer barrel. The strut may have an inner body and an outer body. The exhaust system may include at least one strut hole formed in the inner body, where the at least one strut hole forms a first cooling path for cooling flow in a first direction, and a cavity between the inner body and the outer body, where the cavity forms a second cooling path for the cooling flow in a second direction. The exhaust system may include a purge outlet to purge the cooling flow at the inner barrel.

This application and the resultant patent further provide a method of cooling an exhaust frame of a gas turbine engine. The method may include the steps of flowing a cooling flow from a blower to an inner barrel of the gas turbine engine, directing the cooling flow in a first direction through a first cooling path formed by at least one strut hole in a strut, reversing the cooling flow in a second direction through a cavity between an inner body and an outer body of the strut, and purging the cooling flow at the inner barrel.

This application and the resultant patent further provide an exhaust frame cooling system for use with a gas turbine engine. The exhaust frame cooling system may include an inner barrel, an outer barrel, and a number of struts extending between the inner barrel and the outer barrel. The exhaust frame cooling system may include a number of strut holes forming a first cooling path through respective struts of the number of struts, where the first cooling path directs a cooling flow in a first direction. The exhaust frame cooling system may include an internal strut cavity forming a second cooling path through respective struts of the number of struts, where the second cooling path directs the cooling flow in a second direction, and a purge outlet to purge the cooling flow at the inner barrel.

These and other features and improvements of this application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine including a compressor, a combustor, a turbine, an exhaust frame, and an external load.

FIG. 2 is an end view of an embodiment of an exhaust frame as may be described herein.

FIG. 3 is a cross-sectional view of the exhaust frame of FIG. 2, taken along line 3-3, showing the inner barrel, the outer barrel, and two of the struts.

FIG. 4 is a cross-sectional side view of the exhaust frame of FIG. 2 illustrating an example exhaust frame cooling system.

FIG. 5 is a cross-sectional view along the line 5-5 in FIG. 4.

### DETAILED DESCRIPTION

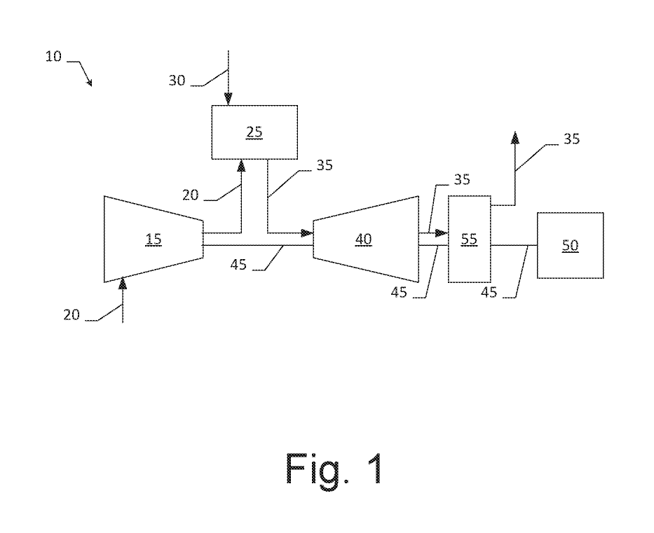

Referring now to the drawings, in which like numerals refer to like elements throughout the several views, FIG. 1 shows a schematic diagram of a gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 and an external load 50, such as an electrical generator and the like via a shaft 45. The flow of combustion gases 35 is delivered from the turbine 40 to an exhaust frame 55 positioned downstream thereof. The exhaust frame 55 may contain and direct the flow of combustion gases 35 to other components of the gas turbine engine 10. For example, the exhaust frame 55 may direct the flow of combustion gases 35 to an exhaust plenum or an exhaust diffuser. Other configurations and other components may be used herein.

The gas turbine engine 10 may use natural gas, various types of syngas, and/or other types of fuels. The gas turbine engine 10 may be any one of a number of different gas turbine engines offered by General Electric Company of Schenectady, New York, including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

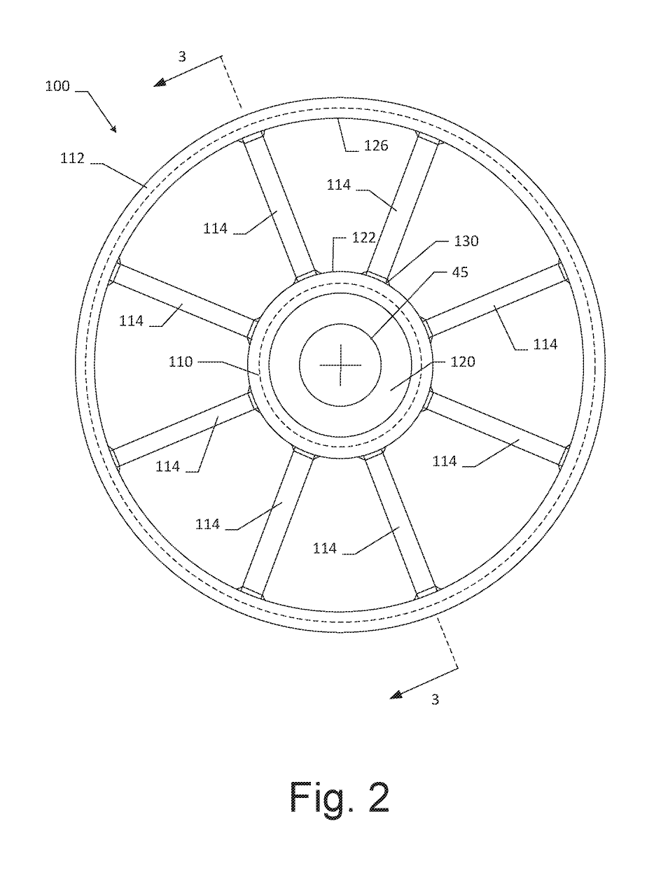

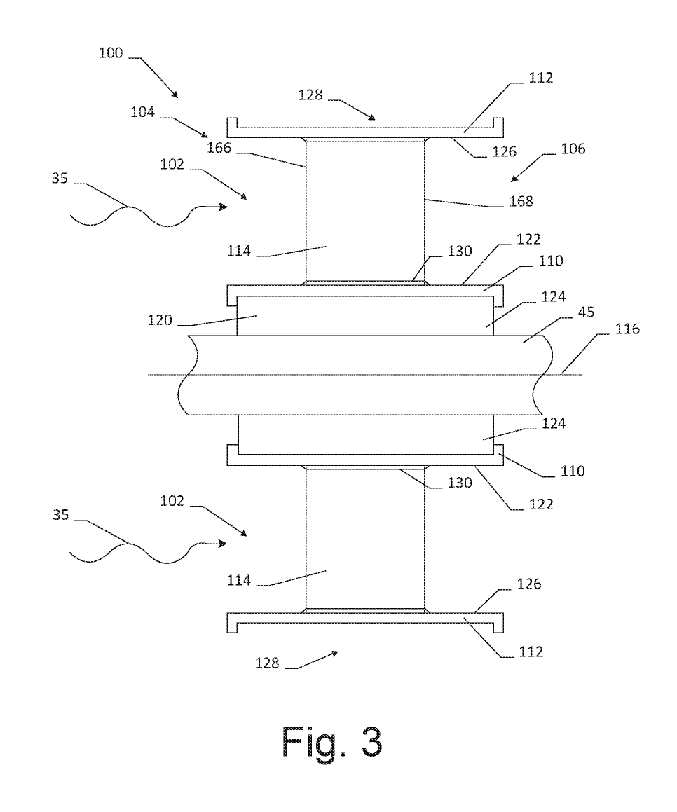

FIGS. 2 and 3 illustrate an embodiment of an exhaust frame 100 as may be described herein. The exhaust frame 100 may be used in the gas turbine engine 10. The exhaust frame 100 may be positioned downstream of the turbine 40 and may be configured to receive the flow of combustion gases 35 flowing along a hot gas path 102 of the gas turbine engine 10. The hot gas path 102 may extend through the turbine 40 and the exhaust frame 100. The exhaust frame 100 may have a leading or upstream end 104 and a trailing or downstream end 106. The exhaust frame 100 may be configured to contain and direct the flow of combustion gases 35 to other components of the gas turbine engine 10, such as an exhaust plenum or an exhaust diffuser positioned downstream of the exhaust frame 100.

The exhaust frame 100 may include an inner barrel 110, an outer barrel 112, and one or more struts 114 extending between the inner barrel 110 and the outer barrel 112. The inner barrel 110 may be formed as a tube shaped body extending axially along and coaxial with a longitudinal axis 116 of the exhaust frame 100. The inner barrel 110 may house a shaft bearing 120 that supports the shaft 45 of the gas turbine engine 10 for rotation therein. The inner barrel 110 may define an inner exhaust frame wall 122 and a shaft bearing cavity 124. The outer barrel 112 may define an outer exhaust frame wall 126, which may in turn define a portion of a purge cavity 128 (e.g., an annular space between the outer casing and the strut).

The outer barrel 112 may be formed as a tube shaped body extending along and coaxial with the longitudinal axis 116 of the exhaust frame 100. The outer barrel 112 may be spaced apart from and positioned radially outward from the inner barrel 110. In this manner, the inner barrel 110 and the outer barrel 112 may define a portion of the hot gas path 102 therebetween (i.e., the annular space between the inner barrel 110 and the outer barrel 112). In some embodiments, the exhaust frame 100 also may include a liner and/or insulation disposed along the inner barrel 110, the outer barrel 112, and/or the struts 114. In such embodiments, the liner may define a portion of the hot gas path 102 extending through the exhaust frame 100.

During operation of the gas turbine engine 10, the combustion gases 35 flowing along the hot gas path 102 may be contained between the inner barrel 110 and the outer barrel 112 and may flow over the struts 114. The inner barrel 110 may be formed as a single component or may include a number of segments joined together to form the inner barrel 110. Similarly, the outer barrel 112 may be formed as a single component or may include a number of segments joined together to form the outer barrel 112. Although the inner barrel 110 and the outer barrel 112 are shown as having circular cross-sectional shapes, other shapes may be used in other configurations.

The struts 114 may extend radially from the inner barrel 110 to the outer barrel 112 with respect to the longitudinal axis 116 of the exhaust frame 100. The struts 114 may be arranged in a circumferential array about the longitudinal axis 116. Although eight struts 114 are shown in FIG. 2, the exhaust frame 100 may include any number of struts 114 extending between the inner barrel 110 and the outer barrel 112. Each strut 114 may be attached at a radially inner end thereof to the inner barrel 110 and may be attached at a radially outer end thereof to the outer barrel 112. In particular, each strut 114 may include a flange 130 at the radially inner end thereof at an interface with the inner barrel 110. The flange 130 may be used to secure the strut 114 to the inner barrel 110. In some embodiments, the flange 130 may be welded to the inner barrel 110 to prevent separation between the strut 114 and the inner barrel 110. For example, a continuous weld extending around a perimeter of the strut 114 along the respective casing 110, 112 may be used to secure the strut 114 to the inner barrel 110. Alternatively, an intermittent weld extending around the perimeter of the strut 114 along the respective casing 110, 112 may be used. In other embodiments, any suitable type or configuration of weld, such as a fillet weld, may be used, while yet other embodiments may not include any welding.

The struts 114 may support the outer barrel 112 and the inner barrel 110. For example, the struts 114 may be load carrying members in the exhaust frame 100. As the hot combustion gases exit the turbine 40 and the shaft 45 rotates, the components in the exhaust frame 100 may experience high temperature conditions. More specifically, the high temperature conditions may cause thermal stress, wear, and/or damage to the struts 114, the inner barrel 110, and/or the outer barrel 112.

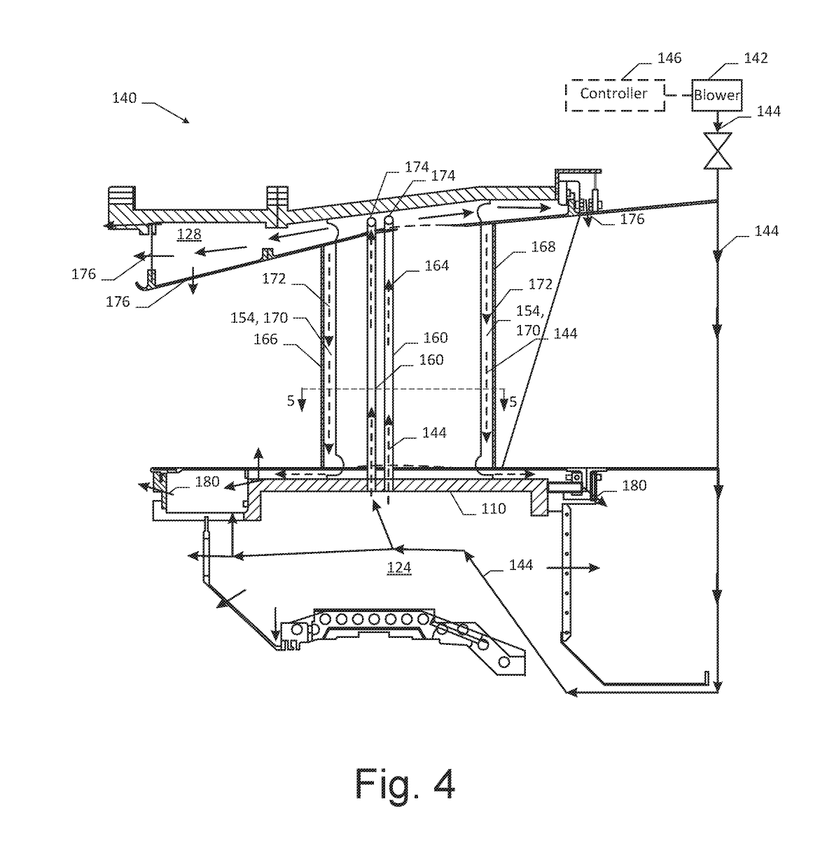

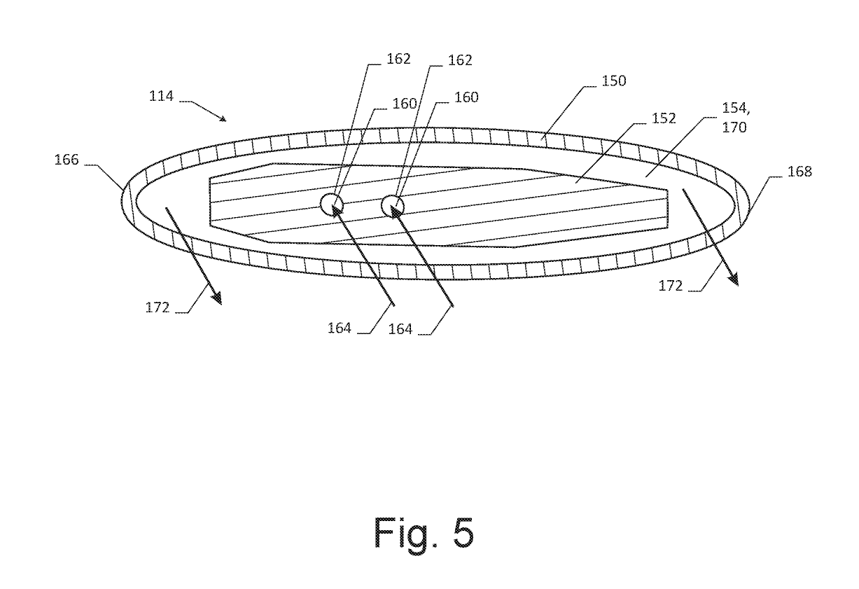

Referring to FIGS. 4 and 5, the exhaust frame 100 may include an exhaust frame cooling system 140. The exhaust frame cooling system 140 may include a blower 142 that generates or provides a cooling fluid, such as relatively cooler air, in a cooling flow 144 to the exhaust frame 100 via one or more cooling flow paths. The source of the cooling fluid may be the compressor of the gas turbine engine 10 or some other external air source. The cooling flow paths may direct the cooling flow 144 through one or more portions of the exhaust frame 100.

The blower 142 may provide the cooling flow 144 to cool the struts 114, the inner barrel 110, and/or the outer barrel 112, thereby reducing the thermal stress, wear, and/or damage to the exhaust frame components. The blower 142 may optionally be coupled to a controller 146 that controls operation of the blower 142. The controller 146 may be any type of programmable logic device, such as a microcomputer and the like. For example, the controller 150 may control a velocity, temperature, and/or amount of cooling fluid output from the blower 142. In some embodiments, a single blower 142 may be used to generate and/or provide the cooling flow 144.

In FIG. 4, the cooling flow 144 may be directed from the blower 142 to the shaft bearing cavity 124 or another internal cavity of the inner barrel 110. The cooling flow 144 may cool the inner barrel 110. From the shaft bearing cavity 124, the cooling flow 144 may be directed to one or more cooling paths. The one or more cooling paths may be formed in or by a portion of the strut 114. Specifically, one or more, or each, of the struts 114 may include cooling flow paths to direct the cooling flow 144 to cool the exhaust frame 100.

For example, in FIG. 5, the strut 114 may include an outer body 150 and an inner body 152. The outer body 150 may have an elliptical, oval, or other geometric shape with having insulation on cooling flow side and may protect the inner body 152 by blocking or reducing heat transfer to the inner body 152. The outer body 150 may be spaced from the inner body 152 to form a cavity 154 in between the inner body 152 and the outer body 150. The cavity 154 may be configured to direct cooling fluid externally along the inner body 152 to provide a thermal barrier between the inner body 152 and the hot combustion gases 35 in the exhaust frame 100 that are external to the outer body 150.

The inner body 152 of the strut 114 may be a load bearing structural support configured to support a mechanical load between the inner barrel 110 and the outer barrel 112 of the exhaust frame 100. The outer body 150 of the strut 114 may not be a load bearing structural support. In an example, the inner body 152 may be made of a different material or steel than the outer body 150. The inner body 152 may have any suitable shape, such as an airfoil shape, a rectangular shape with tapered portions, a trapezoidal shape, or another configuration.

The outer body 150 may have greater thermal resistance to the hot combustion gases 35 than the inner body 150. For example, the inner body 152 may have a lower temperature limit than the outer body 150. In some embodiments, the inner body 152 may have a temperature limit lower than the temperature of the hot combustion gases 35, while the outer body 150 may have a temperature limit substantially above the temperature of the hot combustion gases. Thus, the outer body 150 thermally protects the inner body 152, such that the inner body 152 is able to effectively bear the mechanical load between the inner barrel 110 and the outer barrel 112 of the exhaust frame 100.

The inner body 152 may define one or more first cooling flow paths 160 for the cooling flow 144. The one or more first cooling flow paths 160 may be defined by through holes or strut holes 162 extending through the inner body 152. The first cooling flow paths 160 may direct the cooling flow 144 in a first direction 164. The first direction 164 may be radially outward, from the inner barrel 110 to the outer barrel 112. More specifically, in one example, the first cooling flow paths 160 may direct the cooling flow 144 from the shaft bearing cavity 124 at the inner barrel 110 to the purge cavity 128 at the outer barrel 112.

The inner body 152 may include any number of strut holes 162, such as one or more strut holes, or at least two strut holes. Any number and orientation of strut holes may be included. The strut holes 162 may have any suitable geometry, such as circular, elliptical, oval, or another geometry. The strut holes 162 may be placed anywhere in the inner body 152. In the example of FIG. 5, the inner body 162 may include two strut holes 162 positioned closer to a leading edge 166 than a trailing edge 168 of the strut 114.

The strut 114 may include one or more second cooling flow paths 170. For example, the cavity 154 between the inner body 152 and the outer body 150 may define one or more second cooling flow paths 170. The second cooling flow paths 170 may direct the cooling flow 144 in a second direction 172. The second direction 172 may be radially inward, from the outer barrel 112 to the inner barrel 110. More specifically, in one example, the second cooling flow paths 170 may direct the cooling flow 144 from the purge cavity 128 at the outer barrel 112 to the shaft bearing cavity 124 at the inner barrel 110. The second direction 172 may be opposite the first direction 164.

The cooling flow 144 may enter the first cooling flow paths 160 from the inner barrel 110, or in one embodiment, from the shaft bearing cavity 124. For example, the cooling flow 144 may flow through one or more openings in an inner casing or at the inner exhaust frame wall 122 and enter the first cooling flow paths 160. More specifically, the cooling flow 144 may enter the strut holes 162 from the shaft bearing cavity 124. In some embodiments, the only path for the cooling flow 144 to enter the shaft 114 from the inner barrel 110 may be through the strut holes 162.

The cooling flow 144 may flow through the strut 114 in the first direction 164 and may exit the first cooling flow paths 160 via one or more cross holes 174 located at an end of the first cooling flow paths 160. In some embodiments, a portion of the cooling flow 144 may enter the purge cavity 128 and/or another section of the outer barrel 112 through one or more openings in the outer exhaust frame wall 126 after exiting the first flow paths 160, so as to provide cooling for the outer barrel 112 and the components therein. In such embodiments, the portion of the cooling flow 144 may eventually be purged to the exhaust flow path at one or more first purge openings 176. Some embodiments may not include the first purge opening 176 and/or may not direct the cooling flow to the first purge opening 176.

As the cooling flow 144 exits the first cooling flow paths 160, some or all of the cooling flow 144 may be directed to the second cooling flow paths 170. For example, the cooling flow 144 may be directed through the cross holes 174 and to the second cooling flow paths 170 in the second direction 172. In some embodiments, all of the cooling flow 144 may be directed from the first cooling flow path 160 to the second cooling flow path 170.

The cooling flow 144 may be directed along the second cooling flow paths 170 through the cavity 154 in the second direction 172. The cooling flow 144 may therefore cool a portion of the outer body 150 and the inner body 152 of the strut 114. During operation, high tensile stresses may be exerted on the inner body 152. The stress may cause the flange 130 at the inner barrel 110 to separate from the inner barrel 110 (e.g., “opening”). The second cooling flow path 170 may direct the cooling flow 144 through the cavity 154, so as to reduce the tensile stress by providing a thermal barrier between the outer body 150 and the inner body 152, thereby reducing heat transfer from the inner body 152 to the cooling flow 144 in the first cooling flow paths 150. This cooling flow 144 may keep the outer barrel 112 cooler relative to the inner body 152. By maintaining the inner body 152 at relatively higher temperatures, the inner body 152 may tend to be in compression, which reduces the tensile stress.

By supplying relatively lower temperature air to the outer barrel and/or the outer purge cavity through holes in the strut, and by reversing the cooling flow direction back to the inner barrel, the strut may be maintained at a relatively higher temperature, which may resolve any opening or separation of the flange from the inner barrel.

The cooling flow 144 may exit the second cooling flow paths 170 and may be directed to one or more second purge openings 180 located at the inner barrel 110. In some embodiments, the cooling flow 144 may be directed through both the first cooling flow paths 160 and the second cooling flow paths 170 before the cooling flow 144 is purged at inner barrel 110. In other embodiments, a portion of the cooling flow 144 may be purged at inner barrel 110 before being directed through both the first cooling flow paths 160 and the second cooling flow paths 170.

During cooling, the controller 146 may operate the blower 142 to generate cooling flow 144. The cooling flow 144 may flowed to the inner barrel 110. Portions of the cooling flow 144 may circulate through the inner barrel 110, and then may be directed to exit to the first cooling flow paths 160 in a first direction 164 through the strut 114. A portion of the cooling flow 144 may enter the outer barrel 112 for venting into the exhaust gas path. Some or all of the cooling flow 144 may be reversed to flow in a second direction 172 through the cavity 154 between the inner body 152 and the outer body 150 of the strut 114. The cooling flow 144 may be purged at the inner barrel 110.

Certain embodiments may direct cooling flow through strut holes in the strut, thereby cooling the inner body of the strut, as well as cooling the outer barrel upon exiting the inner body of the strut. The strut may be maintained at a relatively high temperature by reversing the flow direction of the cooling flow through the annulus or cavity between the inner body and the outer body of the strut. As a result, the strut may be in compression, which may force the flange of the strut to remain in contact with the inner barrel and prevent separation. The bearing tunnel temperature and/or a temperature of a shaft bearing cavity may be reduced. An axial temperature gradient at the flange may also be reduced. Embodiments of the disclosure may use smaller blowers with reduced power consumption and may allow for removal of auxiliary components for external outer barrel feeds. Exhaust gas dilution may be reduced, thereby improving performance.

It should be apparent that the foregoing relates only to certain embodiments of this application and resultant patent. Numerous changes and modifications may be made herein by one of ordinary skill in the art without departing from the general spirit and scope of the invention as defined by the following claims and the equivalents thereof.

We claim:

1. An exhaust system for use with a gas turbine engine, comprising:
a strut positioned between an inner barrel and an outer barrel, the strut comprising an inner body and an outer body;
at least one strut hole formed in the inner body, the at least one strut hole forming a first cooling path for cooling flow in a first direction;
a cavity between the inner body and the outer body, wherein the cavity forms a second cooling path for the cooling flow in a second direction; and
a purge outlet to purge the cooling flow at the inner barrel.

2. The exhaust system of claim 1, wherein the first direction is from the inner barrel to the outer barrel and the second direction is from the outer barrel to the inner barrel.

3. The exhaust system of claim 2, wherein the cooling flow enters the first cooling path from the inner barrel and a portion of the cooling flow exits the second cooling path at the inner barrel.

4. The exhaust system of claim 1, further comprising a blower configured to generate the cooling flow.

5. The exhaust system of claim 4, wherein the blower is configured to deliver the cooling flow to the inner barrel.

6. The exhaust system of claim 1, wherein the cooling flow generates a predetermined strut temperature gradient with a single feed cooling flow.

7. The exhaust system of claim 1, further comprising one or more cross holes at an end of the first cooling path, wherein the cooling flow passes through the one or more cross holes to move from the first cooling path to the second cooling path.

8. The exhaust system of claim 1, further comprising an inner body flange at an interface between the inner barrel and the inner body of the strut.

9. The exhaust system of claim 8, wherein the inner body is in compression during operation of the gas turbine engine, such that the inner body flange is in contact with the inner barrel.

10. The exhaust system of claim 1, further comprising:
a bearing cavity at the inner barrel; and
an outer cavity at the outer barrel;
wherein the first cooling path extends between the bearing cavity and the outer cavity.

11. The exhaust system of claim 1, wherein the purge outlet is configured to purge cooling flow that exits the second cooling path.

12. The exhaust system of claim 1, wherein the purge outlet is a first purge outlet, the exhaust system further comprising:
a second purge outlet at the outer barrel, wherein the second purge outlet purges a portion of the cooling flow that exits the first cooling path.

13. The exhaust system of claim 12, wherein the second purge outlet purges the portion of the cooling flow before the cooling flow flows in the second direction.

14. The exhaust system of claim 1, wherein the inner body comprises two strut holes in any angle of orientation to the inner body center line and extending through the inner body.

15. A method of cooling an exhaust frame of a gas turbine engine, comprising:
flowing a cooling flow from a blower to an inner barrel of the gas turbine engine;
directing the cooling flow in a first direction through a first cooling path formed by at least one strut hole in a strut;
reversing the cooling flow in a second direction through a cavity between an inner body and an outer body of the strut; and
purging the cooling flow at the inner barrel.

16. An exhaust frame cooling system for use with a gas turbine engine, comprising:
an inner barrel;
an outer barrel;
a plurality of struts extending between the inner barrel and the outer barrel;
a plurality of strut holes forming a first cooling path through respective struts of the plurality of struts, wherein the first cooling path directs a cooling flow in a first direction;
an internal strut cavity forming a second cooling path through respective struts of the plurality of struts, wherein the second cooling path directs the cooling flow in a second direction; and
a purge outlet to purge the cooling flow at the inner barrel.

17. The exhaust frame cooling system of claim 16, further comprising a single blower configured to generate the cooling flow.

18. The exhaust frame cooling system of claim 16, wherein the second direction is opposite the first direction.

19. The exhaust frame cooling system of claim 16, further comprising one or more cross holes configured to direct the cooling flow from the first cooling path to the second cooling path.

20. The exhaust frame cooling system of claim 16, wherein the cooling flow enters the first cooling path from the inner barrel and a portion of the cooling flow exits the second cooling path at the inner barrel.
